(19) United States
(12) Patent Application Publication
(10) Pub. No.: US 2008/0128041 A1
(43) Pub. Date: Jun. 5, 2008

(54) Duct having silicone inner striping and composition for lubricious stripe coating

(75) Inventor: Richard Paul Clement, Fairview, PA (US)

Correspondence Address: PATENT GROUP 2N;JONES DAY, NORTH POINT, 901 LAKESIDE AVENUE, CLEVELAND, OH, 44114, US

(73) Assignee: The Lamson & Sessions Co.

(21) Appl. No.: 11/999,216

(22) Filed: Dec. 4, 2007

Related U.S. Application Data
(60) Provisional application No. 60/868,449, filed on Dec. 4, 2006.

(51) Int. Cl. F16L 55/00

(52) U.S. Cl. 138/108; 508/163; 138/146

(57) ABSTRACT

A duct having lubricious interior qualities includes a cylindrical continuous polymeric layer and a plurality of longitudinally extending stripes of material coupled to the inside the cylindrical layer. The striping material comprises as a component at least silicone in order to provide a lubricious quality to the interior of the duct. A composition for a striping material for application to the interior of a duct comprises a mixture of a polyethylene component and a silicone component. A coloring component may also be used to color the striping.

### CROSS-REFERENCE TO RELATED APPLICATION

This application claims priority to U.S. Provisional Application No. 60/868,449, filed Dec. 4, 2006, the disclosure of which is incorporated herein by reference in its entirety.

### FIELD

This technology relates to a duct having inner striping and a composition for a lubricious inner striping of a duct for lowering the amount of friction inside the duct.

### BACKGROUND

Ducts are currently utilized for storing cables, such as fiber optic cables, electric cables, and coaxial cables for cable television. These ducts are utilized in construction projects, buried under the ground, or used in other known installations. Ducts are utilized to easily thread various cables throughout an installation, or to replace or upgrade cables within an installation. It is beneficial to provide the interior of ducts with prelubrication in order to allow easy insertion and threading of cables within the duct. Currently known techniques for lubricating pipes include coating the interior of pipes with a silicone material. U.S. Pat. No. 4,892,442 to Shoffner discusses coextruding an inner lubricious layer with an outer layer. The inner lubricious layer may be ribbed and coats the entire inner surface area of the duct. Other techniques for coating the interior of a duct include spray coating the interior with a lubricious material, such as silicone.

### BRIEF DESCRIPTION OF THE DRAWING FIGURES

FIG. 1 is a perspective view of an example duct having part of the wall of the duct enlarged;

FIG. 2 is an end view of the example duct of FIG. 1, also showing the enlarged portion from an end view;

FIG. 3 is another top plan cross-sectional view of an example duct having part of the wall of the duct cut away;

FIG. 4 is an end view of an example duct with the striping having a spacing such that the spacing between stripes is narrower than that depicted in FIG. 2;

FIG. 5 is a cross-sectional view of parts of an extruder utilized for manufacturing a duct having striping;

FIG. 6 is a perspective view of parts of the pin assembly shown in part in FIG. 5, including the nut and the pin; and

FIG. 7 is a perspective view of parts of the pin assembly shown in FIG. 5 including the pin tip and the land.

### DETAILED DESCRIPTION

The examples discussed herein involve known extruding techniques. Therefore, the extruding techniques themselves will not be covered in great detail. The terms duct and tube may be used interchangeably herein to refer to the example duct 10.

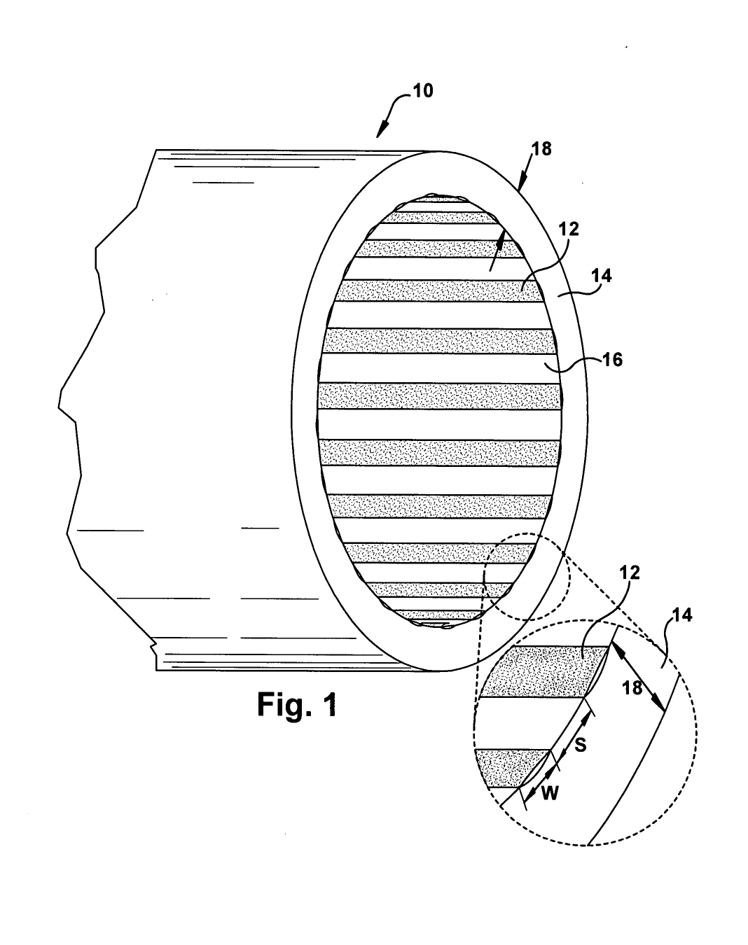

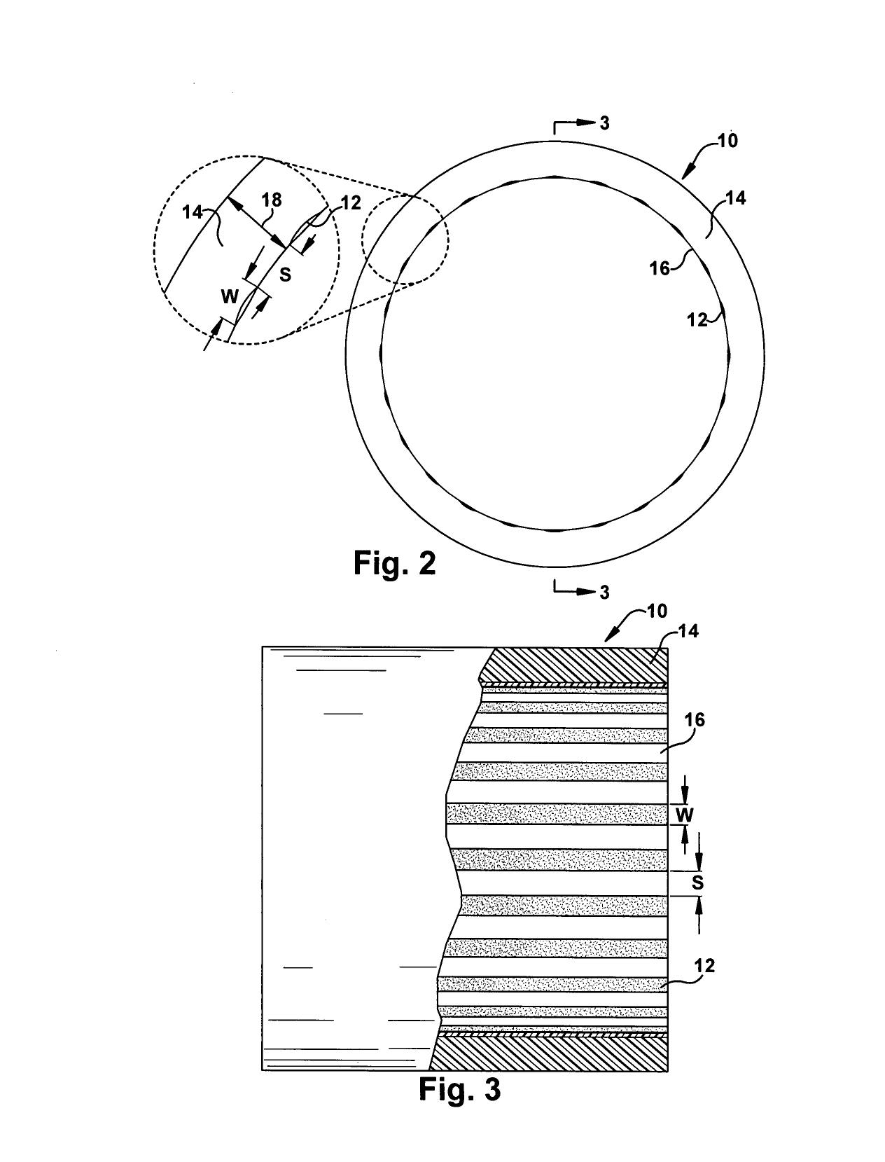

FIGS. 1-4 depict example ducts 10 that incorporate an example lubricious material 12 coupled to the interior of a duct wall 14. The lubricious material is in the form of a plurality of longitudinally extending markings 12 that form a pattern on the interior of the duct wall 14. As shown, the markings or patterns 12 may be formed as multiple stripes 12 that extend continuously and longitudinally inside the duct 10. The stripes 12 have a width W and a spacing S such that portions of the underlying duct wall 14 are visible between the stripes. The stripes are made of a lubricious material that reduces friction inside the duct wall 14. The striping material 12 is utilized to lower the coefficient of friction inside the duct wall 14 such that less friction is encountered by cables that are passed through the interior of the duct wall 14.

The striping material 12 includes as a component a lubricious material, such as silicone, although other materials may also be utilized. The striping material 12 is applied to the interior 16 of the duct and is useful in allowing tubing, cables, and conduits (not shown) to pass easily through the tubing. The duct wall 14 may be made of a polymeric material, such as polyethylene. The striping material 12, depicted in FIGS. 1-4, is exaggerated somewhat in that the striping material 12 will generally not be as thick as that depicted.

One formulation for the striping material 12 is a three part mixture that includes high density polyethylene, color concentrate, and silicone. The polyethylene may be in amounts ranging from about 88% to about 96.5%, with one example amount being about 94%. The polyethylene may alternatively be in the range of about 90% to about 97% of the mixture. The color concentrate may range from about 0.5% to 2% of the mixture, with an example amount being about 1%. The silicone may range from about 3% to 10% of the mixture, with an example amount being about 5%. The color concentrate may be excluded if desired.

One type of polyethylene that may be utilized in the composition is TC46-25 polyethylene copolymer by INEOS Olefins & Polymers USA, of League City, Tex. TC46-25 is a natural, high density polyethylene copolymer designed specifically for telecommunications ducting to meet or exceed the material requirements in conduit specifications ASTM F2160, UL651B, and NEMATC-7. TC45-25 balances stiffness, ESCR and molecular weight to provide required toughness and crush strength for use in the telecommunications industry. Other types of polyethylenes may also be utilized. Other materials having similar properties may also be utilized.

The silicone and color concentrate may be purchased from a company called CLM Industrial Polymers of Oakville, Ontario, Canada. One color concentrate that may be utilized is white CLM product 11003. Other colors may also be utilized including red, orange, yellow, green, blue, grey, brown, and variations thereof without limitation. One silicone material that may be utilized is CLM product 10560. Other materials from other manufacturers may alternatively be utilized, the example ducts not being limited to a particular brand of materials. The materials making up the composition may be provided in pelletized or other form.

The ducting 10 may have any range of thicknesses. For example, one example duct 10 may have a wall thickness 18 of 0.138 inches. Any size tubing may benefit from the example striping. For example, one example duct 14 has an outside diameter of about 1.526 inches and a wall thickness 18 of about 0.138 inches. Another example duct 14 has an outside diameter of 1.488 inches and a wall thickness 18 of 0.109 inches. Tubes can range in diameter from about 8 mm to about 7 inches. Thickness 18 of the ducting may also vary.

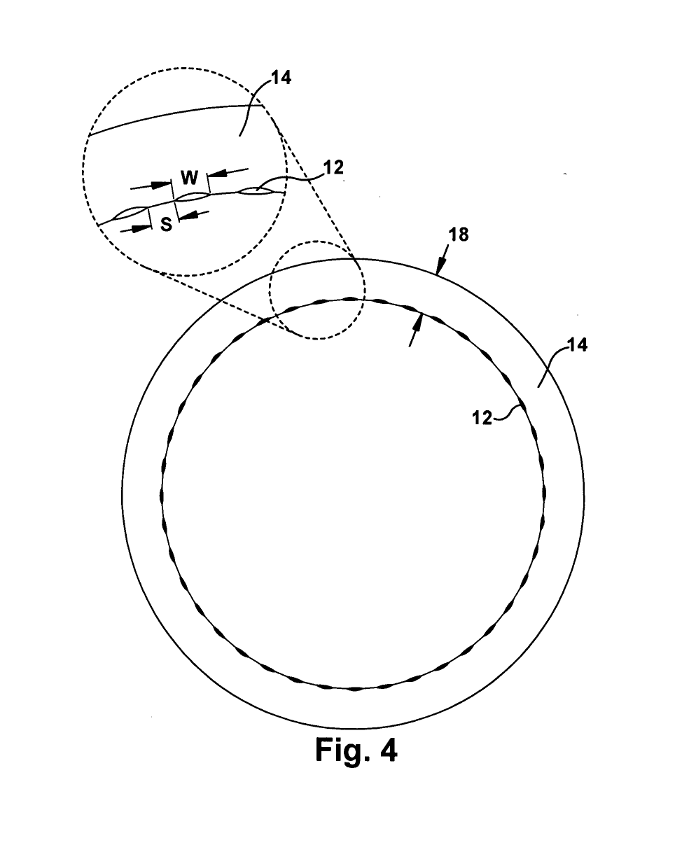

The size and number of stripes 12 can vary depending upon the size of the tube and the particular application. For example, the stripes 12 may range in width W from about 0.04 inches to about 0.08 inches, although any size of stripes 12 is contemplated with the example duct 10 and is dependent in part on the size of the duct wall 14. All the stripes 12 within a single duct 10 may have the same width W. Alternatively, it is possible that varying width stripes within a single duct may be utilized. For the example 1.526 inch OD duct, discussed above and shown in FIGS. 1-3, the stripes 12 shown have a width W of about 0.080 inches. For the 1.488 inch OD duct, shown in FIG. 4, the stripes 12 shown have a width W of about 0.040 inches. The stripes 12 may be evenly spaced around the interior surface 16 of the duct wall 14 or may be unevenly spaced.

The stripes 12 are raised slightly relative to the interior surface 16 of the tubing 14 so that they serve as the first contact point for any cables entering the tubing. The stripes 12 may be raised by about 0.01 inches, or greater or lesser than this amount. The raised stripes 12 present a smaller surface area for any cables that enter the duct 10, which also results in a reduction in the coefficient of friction inside the duct 10. The tubing may be made of any type of material, such as high density polyethylene. The tubing preferably has a composition that allows either chemical interaction with the striping 12, or that firmly adheres to the striping so that the striping does not release from the duct wall 14 during prolonged usage.

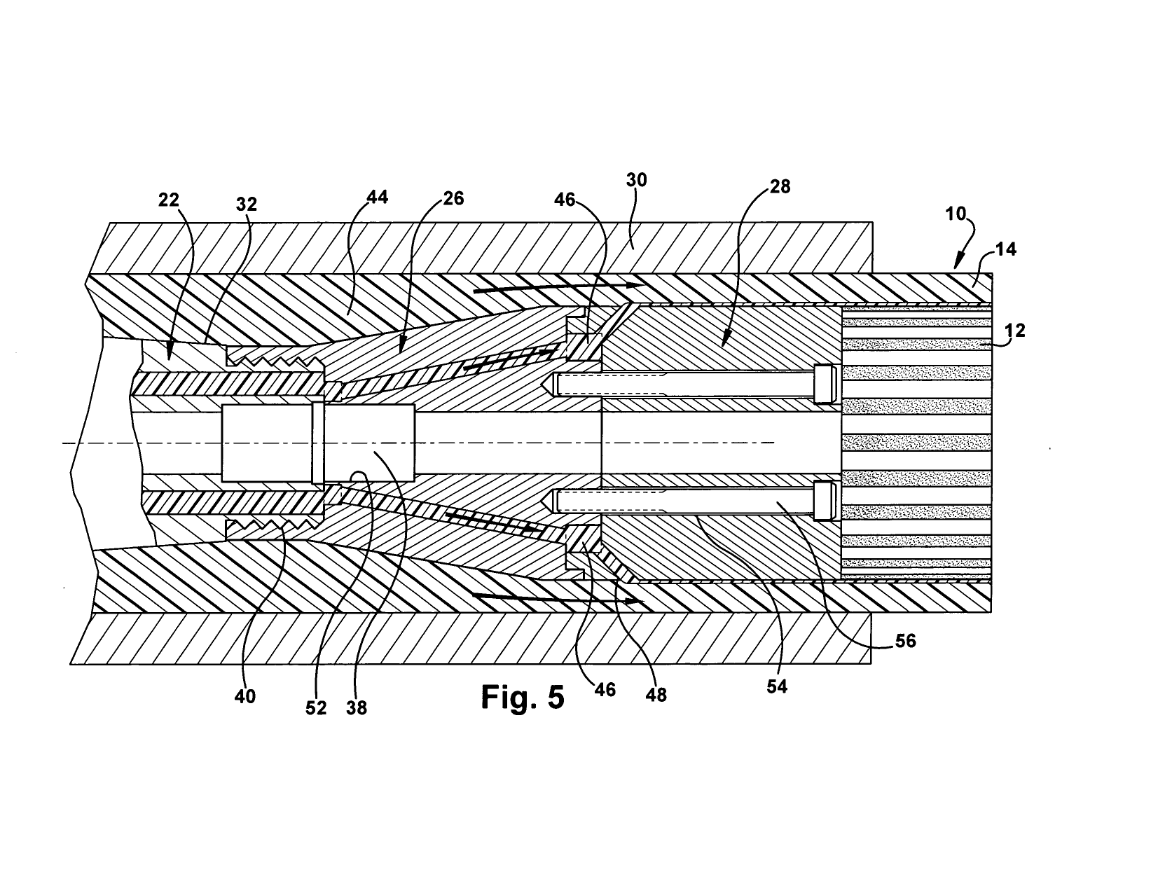

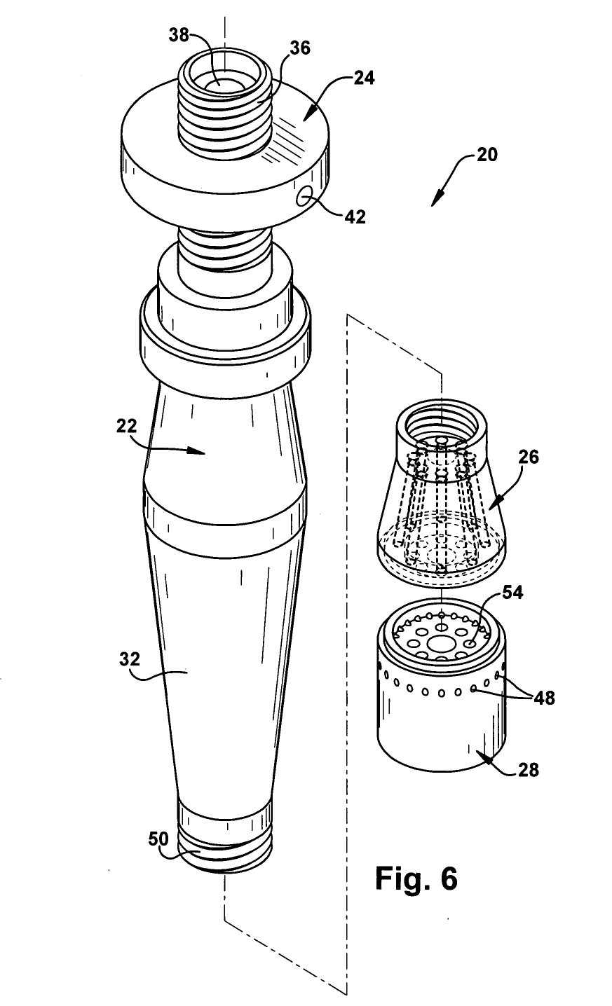

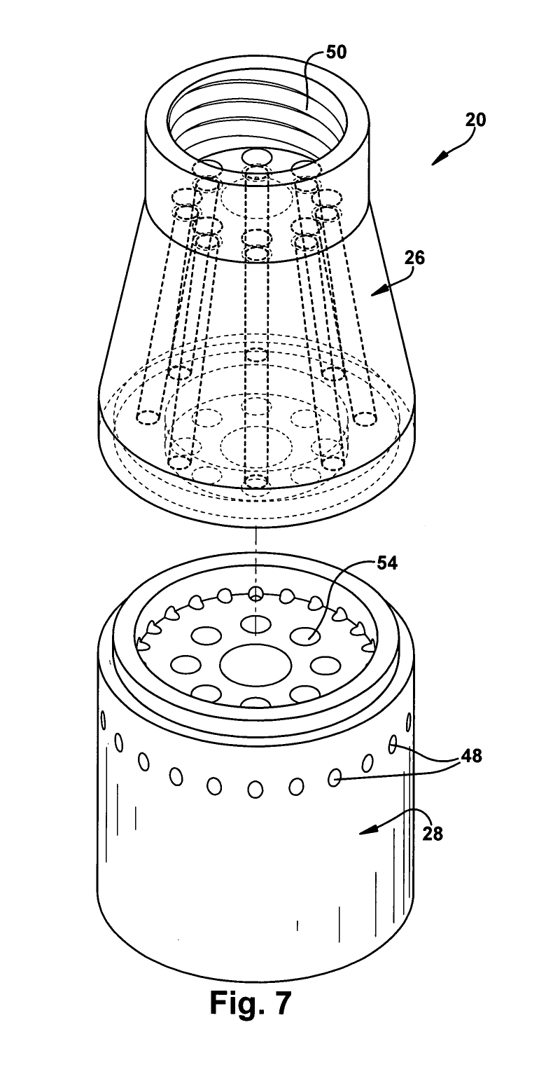

The tooling for manufacturing the example duct 10 is shown in FIGS. 5-7. The tooling consists of a die pin assembly 20. The die pin assembly 20 includes a pin 22, a nut 24, a pin tip 26, and a land 28. The nut 24 couples to the top end of the pin 22 via screw threads 36 and includes a cavity 38 for mating with an extruder. A seal (not shown) seats in the mating cavity 38 between the pin 22 and the extruder. Duct material enters the pin assembly 20 through an inlet 42 in the side of the nut 24. Molten duct material flows into the pin assembly 20 through the nut inlet 42 into a cylindrical counter bore (not shown) in the nut 24. The cylindrical counter bore distributes the molten duct material around the pin 22. Molten duct material travels around the pin between the wall 30 of the die and the exterior surface 32 of the pin 22. The molten duct material then flows around the pin tip 26 where it enters a reservoir 44 formed between the pin tip 26 and the die 30 of the extruder. Molten duct material then travels around the land 28 to form the duct 10.

Molten striping material enters the pin tip assembly 20 at the top end of the pin 22 and travels through the pin 22. The molten striping material enters internal passageways defined inside the pin tip 26 and into a reservoir 46 defined at the top end of the land 28. A series of holes 48 are drilled at an approximately 45 degree angle from the exterior wall of the land 28 to the interior of the land. The holes 48 are for introducing the striping material from the pin assembly 20 to the interior surface 16 of the duct wall 14. Molten striping material is delivered from the reservoir 46 inside the land 28 through the holes 48 in the exterior of the land 28 to the duct wall 14.

The pin tip 26 is coupled to the pin 22 via screw threads 50. A seal 52 is positioned between the pin tip 26 and the pin 22 inside the mating cavity 38 of both parts. The mating cavity 28 is an air hole is positioned inside the pin assembly 20 that extends along the entire length of the pin assembly 20. The air hole 38 may be used for delivering a feed or pull tape (not shown) into the interior of the duct 10. The pull tape is used to feed cables through the tubing during installation and may be a woven polyester material or cord that is placed inside the air hole. The land 28 and pin tip 26 each include longitudinally extending mounting holes 54 used to couple the land 28 to the pin tip 26. Bolts 56 may be inserted through the base of the land 28 into the base of the pin tip 26 to couple the parts together.

The pin assembly 20 is positioned in a die 30 that is mounted in a normal fashion to a primary extruder (not shown). An auxiliary extruder (not shown), capable of delivering enough striping material 12 as needed to the inside 16 of the duct 14, is coupled to the pin assembly 20. The speed of the auxiliary extruder is matched to the speed of the primary extruder to deliver the proper amount of striping material 12 to the inner surface 16 of the duct 14. An automatic additive auger may be used to mix the pelletized components prior to extrusion. Other mixing techniques used to make a uniform mixture may alternatively be used, including hand mixing. Thus, the striping 12 is coextruded with the duct 14.

It was previously known to coat the interior of a duct with silicone. Silicone inner striping is advantageous over previously known techniques because it provides a lubricious surface that lowers the coefficient of friction inside the duct, but uses less material than conventionally known coating techniques. Because of the coextrusion process, the stripes 12 are raised slightly relative to the interior wall of the duct. This presents a smaller surface area inside the duct 14 for contacting cables within the duct, which further lowers the coefficient of friction.

While the lubricious material utilized in the composition has been discussed as silicone. It is anticipated that other alternative lubricious materials may be utilized with equal success and little experimentation. Thus, the disclosure is not limited to the use of silicone as the lubricious material. The term “silicone” as used in the claims is defined to refer to any type of lubricious material that may be extruded with the composition. Moreover, the disclosure is also not limited to the use of high density polyethylene as the base polymer for the composition. Other types of polyethylene materials may alternatively be used, as well as other polymers.

While stripes 12 are shown and described for the pattern inside the duct 14, other patterns or markings may alternatively be utilized. In addition, while the striping 12 is shown to be continuous along the length, the striping 12 may alternatively be non-continuous or intermittent.

Any type of color additive may be utilized. Different colors may be used in different ducts to distinguish, for example, the duct size, the duct type, the striping size or spacing, or to identify other features of the duct. Color may be used as a means to identify the manufacturer or user of the duct, if desired.

The term “substantially” as used herein is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A duct having lubricious interior qualities comprising:
a cylindrical continuous polymeric layer having an interior surface; and
a plurality of longitudinally extending markings of material coupled to the interior surface of the cylindrical layer, said material comprising as a component at least a lubricious material in order to provide a lubricious quality to the interior of the duct.

2. The duct of claim 1, wherein the lubricious materials is silicone and the markings comprises a plurality of longitudinally extending stripes.

3. The duct of claim 2, wherein the material of the cylindrical layer chemically interacts with the stripes such that the stripes are firmly adhered to the cylindrical layer.

4. The duct of claim 2, wherein the cylindrical layer is coextruded with the plurality of stripes to form the duct.

5. The duct of claim 2, wherein the stripes are raised relative to the interior surface of the cylindrical layer.

6. The duct of claim 2, wherein the stripes are substantially evenly spaced on the interior surface of the cylindrical layer.

7. The duct of claim 2, wherein the stripes have a substantially even width.

8. The duct of claim 2, wherein the stripes have a substantially even thickness.

9. The duct of claim 2, wherein the stripes are at least in part unevenly spaced around the interior surface of the cylindrical layer, at least in part have an uneven width relative to one another, and at least in part have an uneven thickness relative to one another.

10. The duct of claim 5, wherein the stripes are raised by about 0.01 inches relative to the interior surface of the cylindrical layer.

11. A composition for a striping material for application to an interior surface of a duct, said composition comprising a mixture of:
a polyethylene component; and
a silicone component;
wherein when said components are combined, the striping material has a lubricious quality.

12. The composition of claim 11, wherein the polyethylene component ranges from 90% to 97% of the mixture and the silicone component ranges from 3% to 10% of the mixture.

13. The composition of claim 11, further comprising a coloring component.

14. The composition of claim 13, wherein the polyethylene component ranges from about 88% to about 96.5%, the coloring component is a color concentrate that ranges from about 0.5% to about 2%, and the silicone ranges from about 3% to about 10% of the mixture.

15. The composition of claim 13, wherein the polyethylene component is about 94% of the mixture, the color concentrate is about 1% of the mixture, and the silicone is about 5% of the mixture.

16. The composition of claim 14, wherein the color concentrate is white.

17. The composition of claim 14, wherein the color concentrate is one of red, orange, yellow, green, blue, grey, or brown.
